(19) United States
(12) Patent Application Publication
(10) Pub. No.: US 2024/0381946 A1
(43) Pub. Date: Nov. 21, 2024

(54) AEROSOL-GENERATING DEVICE WITH OVERMOULDED BUTTON

(71) Applicant: PHILIP MORRIS PRODUCTS S.A., Neuchatel (CH)

(72) Inventors: Dani Ruscio, Neuchatel (CH); Teck Yan Chan, Singapore (SG)

(21) Appl. No.: 18/578,493

(22) PCT Filed: Jul. 13, 2022
(86) PCT No.: PCT/EP2022/069627

§ 371 Date: Jan. 11, 2024

(30) Foreign Application Priority Data
Jul. 15, 2021 (EP) 21185770.1

(51) Int. Cl. A24F 40/70; B29C 45/14; B29L 31/00

(52) U.S. Cl. CPC A24F 40/70; B29C 45/14311; B29C 45/14344; B29C 2045/14327; B29L 2031/7414

(57) ABSTRACT

The invention relates to a method for assembling an aerosol-generating device. The method comprises a step of providing an outer shell (10) for an aerosol-generating device. The outer shell is configured to internally receive a frame assembly (16). The frame assembly comprises a push-activated switch. The method comprises a step of providing a through-hole on a wall of the outer shell. The method comprises a step of fixing a button (12) onto the outer shell to cover the through-hole. The method comprises a step of inserting the frame assembly into the outer shell such that the button (12) overlays the push-activated switch. The invention further relates to an aerosol-generating device.

The present disclosure relates to a method for assembling an aerosol-generating device. The present disclosure further relates to an aerosol-generating device.

It is known to provide an aerosol-generating device for generating an inhalable vapor. Such devices may heat an aerosol-forming substrate contained in an aerosol-generating article without burning the aerosol-forming substrate. The aerosol-generating article may have a shape suitable for insertion of the aerosol-generating article into a heating chamber of the aerosol-generating device. For example, the aerosol-generating article may have a rod shape. A heating element may be arranged in or around the heating chamber for heating the aerosol-forming substrate once the aerosol-generating article is inserted into the heating chamber of the aerosol-generating device.

It is known to provide an aerosol-generating device comprising an outer shell which encloses interior components housed within the shell. Interior components are, for example, components of a heater assembly, a battery, and a printed circuit board (PCB) comprising a push-activated switch for operating the device.

It is known to provide a button which allows for a user to operate the switch located within the outer shell. For example, the button may be fixed to the switch and may protrude outside the outer shell through a hole in the outer shell. Thus, when a user pushes the button, the button pushes the push-activated switch.

In some devices, the device architecture is such that the interior components are mounted on a frame assembly. The outer shell is arranged to encase the inner frame assembly.

In aerosol-generating devices comprising a frame assembly and an outer shell, the walls of the outer shell may often be desired to be very thin. A thin-walled shell may, for example, reduce material costs, or may help providing a light-weight and compact device.

In order to allow for a compact architecture of the aerosol-generating device, the design may be such that the inner frame fits very closely into the outer shell. Thus, there may be only very little space between the frame assembly and the outer shell when the frame assembly is slid into the outer shell.

The assembly of aerosol-generating devices comprising an inner frame assembly and an outer shell can include a step where the frame assembly is inserted into the outer shell. A button may then be installed afterwards in an additional step. For example, the button may be fixed to the frame assembly and may protrude through a through-hole in the outer shell.

It would be desirable to provide an aerosol-generating device comprising a button for a user to operate a switch which can be assembled by inserting an inner frame into an outer shell. It would be desirable to provide an aerosol-generating device which is easy to assemble. It would be desirable to provide an aerosol-generating device which is reproducibly machine assembled.

It would be desirable to provide an aerosol-generating device that avoids or reduces gaps between the button and a wall of the outer shell adjacent to the button. It would be desirable to provide an aerosol-generating device which comprises a water-tight sealing.

According to an embodiment of the invention there is provided a method for assembling an aerosol-generating device. The method may comprise a step of providing an outer shell for an aerosol-generating device. The outer shell may be configured to internally receive a frame assembly. The frame assembly may comprise a push-activated switch. The method may comprise a step of providing a through-hole on a wall of the outer shell. The method may comprise a step of fixing a button onto the outer shell to cover the through-hole. The method may comprise a step of inserting the frame assembly into the outer shell such that the button overlays the push-activated switch.

According to an embodiment of the invention there is provided a method for assembling an aerosol-generating device. The method comprises a step of providing an outer shell for an aerosol-generating device. The outer shell is configured to internally receive a frame assembly. The frame assembly comprises a push-activated switch. The method comprises a step of providing a through-hole on a wall of the outer shell. The method comprises a step of fixing a button onto the outer shell to cover the through-hole. The method comprises a step of inserting the frame assembly into the outer shell such that the button overlays the push-activated switch.

The button may be fixed directly onto the outer shell. The step of fixing the button onto the outer shell may be carried out before the step of inserting the frame assembly into the outer shell. The frame assembly may be slidably inserted into the outer shell.

By fixing the button onto the outer shell, the aerosol-generating device can be assembled by inserting the inner frame into an outer shell. An additional step of fixing a button to the device after installing a shell and an inner frame assembly is avoided. Thereby, a method which may allow an easy assembly of an aerosol-generating device may be provided. A method which may allow to reproducibly assemble an aerosol-generating device by a machine is provided. By fixing the button onto the outer shell, gaps between the button and a wall of the outer shell adjacent to the button may be reduced or avoided. By reducing gaps, a water-tight sealing may be provided. By reducing gaps, an optically more appearing device may be provided.

The button may be fixed onto the outer shell to cover the through-hole so as to provide a water-tight seal between the button and the outer shell. The seal may be water-tight according to IPX7.

The outer shell may comprise a wall. The wall of the outer shell may comprise an outer surface and an opposing inner surface. The outer surface of the wall of the outer shell faces towards the exterior of the aerosol-generating device and the inner surface of the wall of the outer shell faces towards the inside of the aerosol-generating device. In the assembled state, the inner surface of the wall of the outer shell faces towards the frame assembly.

The wall of the outer shell may circumscribe a hollow interior shaped for receiving the frame assembly. The wall of the inner shell may form a generally hollow cylindrical shape. At least one end face of a hollow cylinder formed by the wall of the outer shell may be at least partially open such that the frame assembly may be slidingly inserted into the outer shell along the open end face.

The outer shell may comprise a hollow cylindrical shape. The frame assembly may comprise a cylindrical shape. The frame assembly may comprise a shape configured to closely fit within the outer shell.

The wall of the outer shell may be thin. A thickness of the wall of the outer shell may be one millimeter or less than one millimeter, for example about 0.8 millimeter. A thin-walled shell may be provided, for example, for saving material costs, or for providing a light-weight and compact device.

The through-hole may be a hole in the wall of the outer shell. The through-hole may have a round shape.

The button may comprise a flexible material. For example, the button may comprise an elastomeric plastic material. The button may be deformable. For example, the button may be deformed when a user presses a finger onto the button. The button may deform so as to contact and activate the push-activated switch.

The button may comprise an outer surface and an opposing inner surface. When the button is fixed onto the outer shell, the outer surface of the button faces towards the exterior of the aerosol-generating device and the inner surface of the button faces towards the inside of the aerosol-generating device. The outer surface of the button may comprise a protuberance or bump for enabling a haptic feedback for a user. A user may thus feel when a finger of a user is in a correct position to push the button. A more comfortable operation of the device may be made possible.

The button may be permanently fixed onto the outer shell. The button may be irreversibly fixed onto the outer shell. A permanently or irreversibly fixed button may not be configured to be removed or reattached by a user.

The button may be fixed directly onto the outer shell. The button may thus be permanently anchored directly to the outer shell.

The button may be fixed onto the outer shell by a moulding process.

By moulding the button onto the outer shell, the button may be fixed to a thin wall of an outer shell. By moulding the button onto the outer shell, additional fixation means which may protrude in a direction towards the interior of the outer shell may be avoided. Thereby, it may be possible to insert the frame assembly into the outer shell such that the button overlays the push-activated switch even if the design of the aerosol-generating device is such that the inner frame fits very closely into the outer shell.

The moulding process may be an overmoulding process. The moulding process may be an injection overmoulding process. The moulding process may be a plastic injection overmoulding process.

The moulding process may comprise a step of positioning an outer mold on top of the through-hole from an outer side of the outer shell. The moulding process may comprise a step of positioning an inner mold beneath the through-hole from an inner side of the outer shell. The moulding process may comprise a step of injecting molten material into a cavity formed between the outer mold and the inner mold to form the button. The molten material may be injected via channels in the inner mold. Alternatively or in addition, the molten material may be injected via channels in the outer mold.

The method may comprise a step of providing a groove onto the outer shell. The thickness of the wall of the outer shell may be reduced at the position of the groove. For example, the thickness of the wall of the outer shell may be reduced at the position of the groove by between about 10 percent to about 90 percent. The thickness of the wall of the outer shell may be reduced at the position of the groove by between about 10 percent to about 30 percent. The thickness of the wall of the outer shell may be reduced at the position of the groove by between about 70 percent to about 90 percent. The thickness of the wall of the outer shell may be reduced at the position of the groove by between about 30 percent to about 70 percent, preferably between about 40 percent to about 60 percent.

The thickness of the wall of the outer shell at the position of the groove may be between 0.2 millimeter and 0.7 millimeter, preferably between 0.3 millimeter and 0.5 millimeter.

The groove may be provided onto the inner side of the wall of the outer shell. The groove may be provided onto the outside of the outer shell. The groove may be provided onto the outer side of the wall of the outer shell. The groove may be provided around the periphery of the through-hole. The button may be fixed onto the groove of the outer shell.

The groove may be provided by machining.

The method may comprise a step of providing a corrugated retaining structure onto the groove before fixing the button onto the groove. The corrugated surface structure may be a roughened portion of the surface of the wall of the outer shell at the position of the groove.

The corrugated retaining structure may comprise a pitch pattern.

The pitch pattern may comprise a grid shape of squared pitches. A side length of a squared pitch may be between 0.1 millimeter and 0.4 millimeter, preferably about 0.2 millimeters. A grid groove between pitches may be at least 0.03 millimeter in depth, for example between 0.03 millimeter and 0.10 millimeter. The pitch pattern may comprise a grid shape of squared pitches of about 0.2 millimeters in side length separated by grid grooves of at least 0.03 millimeters in depth.

The corrugated retaining structure may be provided by a laser engraving process.

The method may comprise a step of applying an adhesive onto a surface of the groove before fixing the button onto the groove. The method may comprise a step of applying an adhesive onto the corrugated retaining structure before fixing the button onto the groove.

The adhesive may be applied by a spraying process.

The adhesive may be a one-coat adhesive composed of a mixture of polymers, curatives and pigments dissolved in an organic solvent system.

The adhesive may comprise about 50% to 55% of methyl ethyl ketone, about 20% to 25% of an epoxy resin; about 11% to 20% of ester solvents, about 10% to 15% of xylene, about 1% to 5% of ethyl benzene, and about 0.1% to 0.9% of a silane monomer.

The adhesive may be Chemlok® 213 Adhesive as available by LORD Corporation.

The outer shell and the button may comprise different materials. The outer shell may be made of a rigid material and the button may be made of a flexible material. The outer shell may comprise a metal, preferably aluminium. The button may comprise a plastic material, preferably a thermoplastic material, more preferably thermoplastic polyurethane. The outer shell may be made of a metal and the button may be made of plastics. The outer shell may be made of aluminium and the button may be made of thermoplastic polyurethane.

For example, the button may be fixed onto the outer shell by a moulding process and the outer shell may comprise a metal and the button may comprise plastic material. For example, the button may be fixed onto the outer shell by a moulding process and the outer shell may be made of a metal and the button may be made of plastic material.

Fixing, preferably by moulding, the button onto a groove of the outer shell as described herein may additionally improve the durability of the connection of a plastic button fixed to a metallic outer shell. Providing a corrugated retaining structure on the groove of the outer shell as described herein may additionally improve the durability of the connection of a plastic button fixed to a metallic outer shell. Providing glue onto the corrugated retaining structure on the groove of the outer shell as described herein may additionally improve the durability of the connection of a plastic button fixed to a metallic outer shell.

The button may be arranged flush with an inner surface of a wall of the outer shell. An inner surface of the button may be arranged flush with an inner surface of a wall of the outer shell. This may facilitate smooth insertion of the frame assembly into the outer shell.

The button may be arranged flush with an outer surface of a wall of the outer shell. An outer surface of the button may be arranged flush with an outer surface of a wall of the outer shell.

As used herein, the term ‘flush’ means that the button is levelled with the wall of the outer shell. The button may thus fill the through-hole in the wall of the outer shell without further protruding towards one or both of an interior of the outer shell and an exterior of the outer shell.

The button may be arranged flush with the wall of the outer shell apart from a central bump of the button at an outer surface of the outer shell. The bump may serve to provide for a tactile haptic feedback for a user.

Using a moulding process as described herein may be particularly advantageous to achieve a flush arrangement of the button and the wall of the outer shell.

The method may comprise, after the step of inserting the frame assembly into the outer shell, a step of securely attaching the frame assembly within the outer shell. The frame assembly may be securely attached within the outer shell by screwing a retainer element to an insertion end of the outer shell.

Preferably, the aerosol-generating device comprises control electronics for controlling operation of the aerosol-generating device. The control electronics may be provided on a printed circuit board (PCB). The control electronics may be connected to the push-activated switch. The control electronics may be configured to change an operating state of the aerosol-generating device based on a signal received from the push-activated switch.

The frame assembly may comprise the control electronics of the aerosol-generating device.

For example, the push-activated switch may be a toggle switch, a press switch, or may utilize a capacitive sensor.

Preferably, the aerosol-generating device comprises a heater assembly for heating an aerosol-forming substrate. The heater assembly may be an electric heater assembly. The electric heater assembly may comprise a resistive heating element. The electric heater assembly may utilize inductive heating and may comprise an induction coil and a susceptor.

The frame assembly may comprise at least a portion of the heater assembly of the aerosol-generating device. The frame assembly may comprise a resistive heating element. The frame assembly may comprise an induction coil and a susceptor. The frame assembly may comprise an induction coil and a susceptor may be part of an aerosol-forming article to be used with the aerosol-generating device.

Preferably, the aerosol-generating device comprises a power supply configured to supply power to the heater of the aerosol-generating device. The power supply preferably comprises a power source. Preferably, the power source is a battery, such as a lithium ion battery. As an alternative, the power source may be another form of charge storage device such as a capacitor. The power source may require recharging. For example, the power source may have sufficient capacity to allow for the continuous generation of aerosol for a period of around six minutes or for a period that is a multiple of six minutes. In another example, the power source may have sufficient capacity to allow for a predetermined number of puffs or discrete activations of the heater assembly.

The power supply may comprise control electronics. The control electronics may comprise a microcontroller. The microcontroller is preferably a programmable microcontroller. The electric circuitry may comprise further electronic components. The electric circuitry may be configured to regulate a supply of power to the heater assembly. Power may be supplied to the heater assembly continuously following activation of the system or may be supplied intermittently, such as on a puff-by-puff basis. The power may be supplied to the heater assembly in the form of pulses of electrical current.

The frame assembly may comprise the power supply of the aerosol-generating device.

The method for assembling an aerosol-generating device may comprise the following steps in the following order. First, providing the outer shell for an aerosol-generating device. Second, providing a through-hole on a wall of the outer shell. Third, providing a groove onto the outside of the outer shell around the periphery of the through-hole and, optionally, providing a corrugated retaining structure onto a surface of the groove and, optionally, providing glue onto the corrugated retaining structure. Fourth, fixing a button onto the groove of the outer shell to cover the through-hole. Preferably, the button is fixed onto the groove by a moulding process. Fifth, inserting the frame assembly into the outer shell such that the button overlays a push-activated switch of the frame assembly.

According to an embodiment of the invention there is provided an aerosol-generating device obtainable by the method as described herein.

According to an embodiment of the invention there is provided an aerosol-generating device comprising an outer shell and a frame assembly. The outer shell comprises a button extending over a through-hole of the outer shell. The button is fixed directly onto the outer shell. The frame assembly comprises a push-activated switch. The frame assembly is slidably inserted into the outer shell such that the button overlays the push-activated switch.

The outside of the outer shell may comprise a groove around the periphery of the through-hole. The groove may comprise a laser engraved pattern. Glue may be applied onto the laser engraved pattern. The button may be moulded onto the groove.

As used herein, the term “aerosol-forming substrate” refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or liquid or may comprise both solid and liquid components. An aerosol-forming substrate may be part of an aerosol-generating article.

As used herein, the term ‘aerosol-generating article’ refers to an article comprising an aerosol-forming substrate that is capable of releasing volatile compounds that can form an aerosol. An aerosol-generating article may be disposable. An aerosol-generating article comprising an aerosol-forming substrate comprising tobacco may be referred to herein as a tobacco stick.

As used herein, the term ‘aerosol-generating device’ refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomiser, such as an electric heater, to heat the aerosol-forming substrate to form an aerosol.

As used herein, the term ‘aerosol-generating system’ refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

Below, there is provided a non-exhaustive list of non-limiting examples. Any one or more of the features of these examples may be combined with any one or more features of another example, embodiment, or aspect described herein.
Example A: A method for assembling an aerosol-generating device comprising steps of,
providing an outer shell for an aerosol-generating device, the outer shell being configured to internally receive a frame assembly comprising a push-activated switch;
providing a through-hole on a wall of the outer shell;
fixing a button onto the outer shell to cover the through-hole; and
inserting the frame assembly into the outer shell such that the button overlays the push-activated switch.
Example B: The method of Example A, wherein the step of fixing the button onto the outer shell is before the step of inserting the frame assembly into the outer shell.
Example C: The method of Example A or Example B, wherein the button is fixed onto the outer shell by a moulding process.
Example D: The method of Example C, wherein the moulding process is an injection overmoulding process, preferably, a plastic injection overmoulding process.
Example E: The method of Example D, wherein the moulding process comprises steps of,
positioning an outer mold on top of the through-hole from an outer side of the outer shell;
positioning an inner mold beneath the through-hole from an inner side of the outer shell; and
injecting, via channels in the inner mold, molten material into a cavity formed between the outer mold and the inner mold to form the button.
Example F: The method of any of the preceding examples, comprising a step of providing a groove onto the outside of the outer shell around the periphery of the through-hole,
wherein the button is fixed onto the groove of the outer shell.
Example G: The method of Example F, wherein the groove is provided by machining.
Example H: The method of Example For Example G, comprising a step of providing a corrugated retaining structure onto the groove before fixing the button onto the groove.
Example I: The method of Example H, wherein the corrugated retaining structure comprises a pitch pattern.
Example J: The method of Example I, wherein the pitch pattern comprises a grid shape of squared pitches of about 0.2 millimeters in side length separated by grooves of at least 0.03 millimeters in depth.
Example K: The method of any of Examples H to J, wherein the corrugated retaining structure is provided by a laser engraving process.
Example L: The method of any of Examples H to K, comprising a step of applying an adhesive onto the corrugated retaining structure before fixing the button onto the groove.
Example M: The method of Example L, wherein the adhesive is applied by a spraying process.
Example N: The method of Example L or Example M, wherein the adhesive is a one-coat adhesive composed of a mixture of polymers, curatives and pigments dissolved in an organic solvent system.
Example O: The method of Example N, wherein the adhesive comprises about 50% to 55% of methyl ethyl ketone, about 20% to 25% of an epoxy resin; about 11% to 20% of ester solvents, about 10% to 15% of xylene, about 1% to 5% of ethyl benzene, and about 0.1% to 0.9% of a silane monomer.
Example P: The method of any of the preceding examples, wherein the outer shell and the button comprise different materials, preferably, wherein one or both of the outer shell comprises a metal, preferably aluminium, and the button comprises plastics, preferably thermoplastic polyurethane.
Example Q: The method of any of the preceding examples, wherein the button is arranged flush with an inner surface of a wall of the outer shell to facilitate smooth insertion of the frame assembly into the outer shell.
Example R: The method of Example Q, wherein the button is arranged flush with the wall of the outer shell apart from a central bump at an outer surface of the outer shell to allow for a tactile haptic feedback.
Example S: The method according to any of the preceding examples, wherein the outer shell comprises a hollow cylindrical shape and the frame assembly comprises a cylindrical shape.
Example T: The method according to any of the preceding examples, wherein a thickness of the wall of the outer shell is less than about one millimeter.
Example U: The method according to any of the preceding examples, comprising, after the step of inserting the frame assembly into the outer shell, a step of securely attaching the frame assembly within the outer shell, preferably, by screwing a retainer element to an insertion end of the outer shell.
Example V: The method according to any of the preceding examples, wherein the button is fixed onto the outer shell to cover the through-hole so as to provide a water-tight seal between the button and the outer shell according to IPX7.
Example W: An aerosol-generating device obtainable by the method of any of the preceding examples.
Example X: An aerosol-generating device, comprising
an outer shell comprising a button extending over a through-hole of the outer shell, wherein the button is fixed directly onto the outer shell; and
a frame assembly comprising a push-activated switch, wherein the frame assembly is slidably inserted into the outer shell such that the button overlays the push-activated switch.
Example Y: The aerosol-generating device of Example X, wherein the outside of the outer shell comprises a groove around the periphery of the through-hole, wherein the groove comprises a laser engraved pattern, wherein glue is applied onto the laser engraved pattern, and wherein the button is moulded onto the groove.

Features described in relation to one embodiment may equally be applied to other embodiments of the invention.

The invention will be further described, by way of example only, with reference to the accompanying drawings in which:

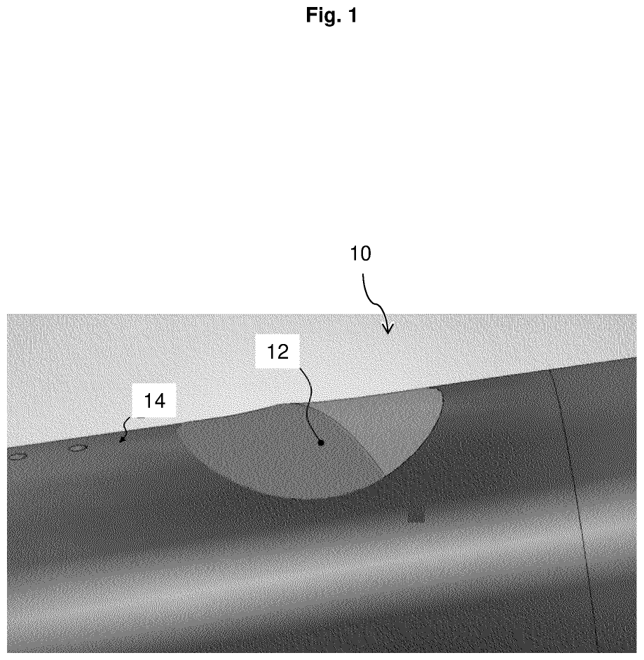

FIG. 1 shows a button fixed onto an outer shell;

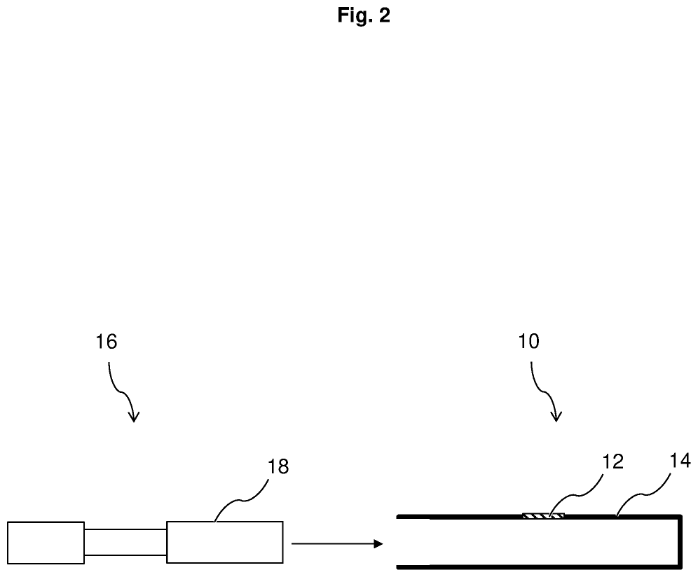

FIG. 2 shows insertion of a frame assembly into an outer shell;

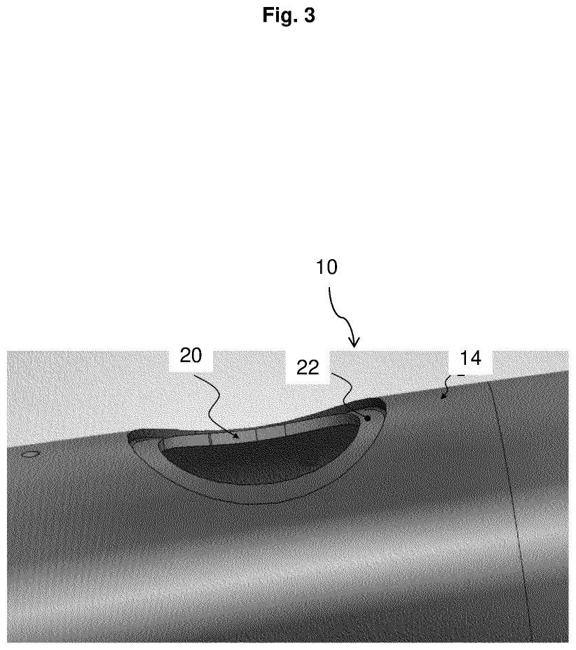

FIG. 3 shows a through-hole of an outer shell;

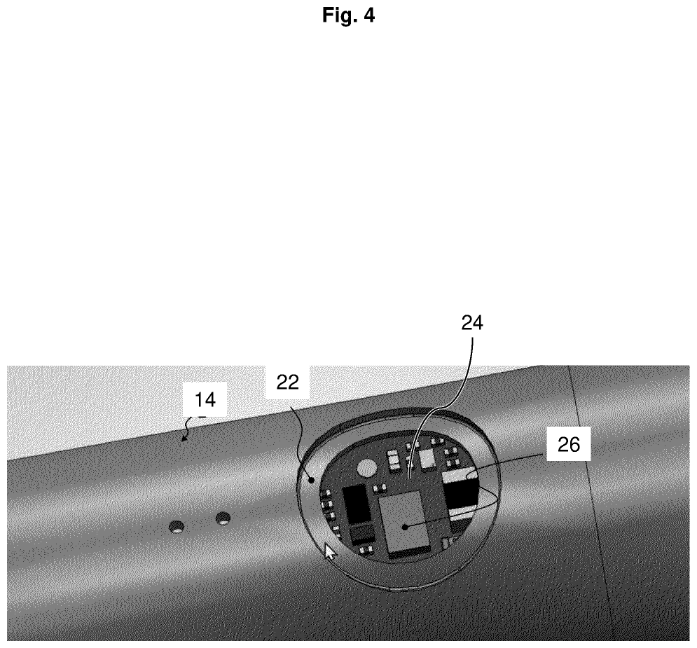

FIG. 4 shows a frame assembly inserted into an outer shell;

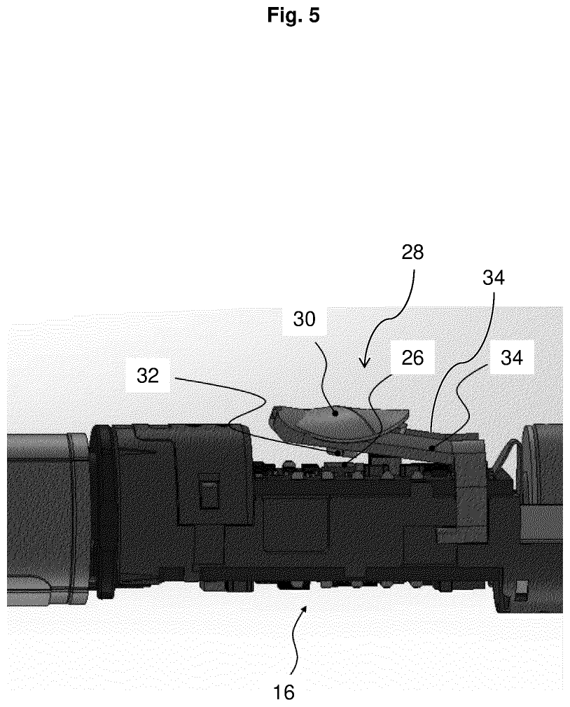

FIG. 5 shows a frame assembly;

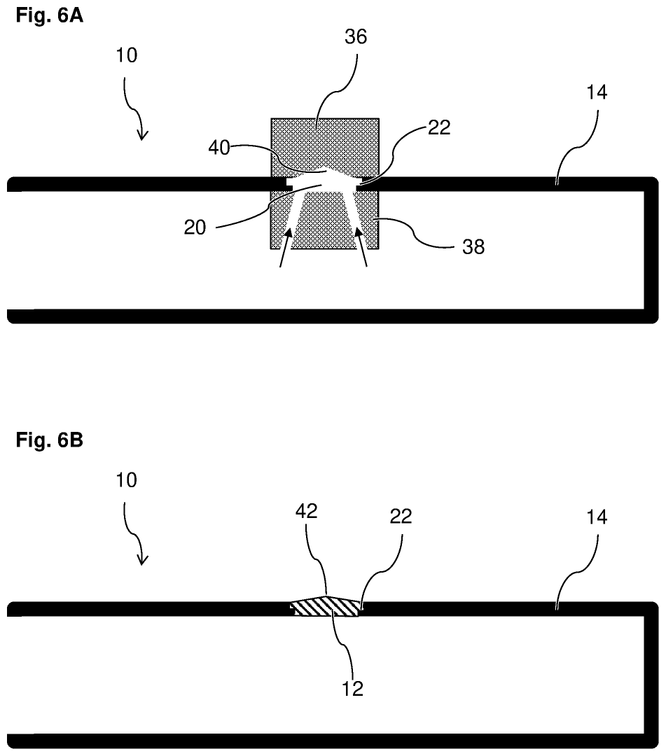

FIG. 6A and FIG. 6B show a moulding process; and

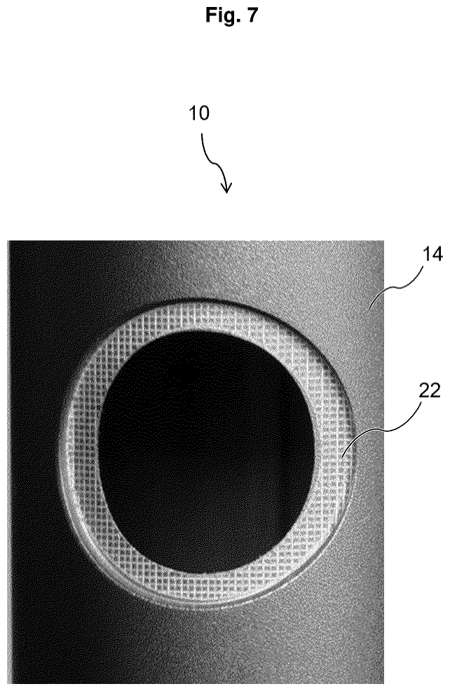

FIG. 7 shows a laser-engraved patter on a groove.

FIG. 1 shows a portion of an outer shell 10 of an aerosol-generating device. A button 12 is fixed onto a wall 14 of the outer shell 10. The button 12 comprises a central bump at an outer surface of the outer shell 10. The central bump provides a tactile haptic feedback for a user.

FIG. 2 schematically shows a frame assembly 16 to be inserted into an outer shell 10. An arrow indicates slidable insertion of the frame assembly 16 into the outer shell 10. The frame assembly 16 has a generally cylindrical shape. The outer shell 10 has a corresponding shape of a hollow cylinder with an open end to allow for the frame assembly 16 to be slidably inserted into the outer shell 10. Particularly, a battery component 18 may be a place demanding component of the frame assembly 16. In order to allow for a compact architecture of the aerosol-generating device, the battery component 18 of the frame assembly 16 fits very closely into the outer shell 10. Thus, there is only very little space between the frame assembly 16 and the outer shell 10 when the frame assembly 16 is slid into the outer shell 10. The button 12 fixed to the outer shell 10 is arranged flush with an inner surface of the wall 14 of the outer shell 10. Thereby, smooth insertion of the frame assembly 16 into the outer shell 10 is made possible.

FIG. 3 shows a through-hole 20 of an outer shell 10. There is provided a groove 22 onto the outside of the outer shell 10. The groove 22 is provided onto the outer side of the wall 14 of the outer shell 10. The groove 22 is provided around the periphery of the through-hole 20. A button (not shown) may be fixed onto the groove of the outer shell 10.

FIG. 4 shows a portion of an aerosol-generating device with a frame assembly being inserted into an outer shell. A groove 22 on the outer wall 14 of the outer shell is provided around the through-hole. For illustrative purposes, a button is not shown. A printed circuit board 24 is part of the inserted frame assembly and is visible through the open through-hole. The printed circuit board 24 comprises a push-activated switch 26.

FIG. 5 shows a portion of frame assembly 16 comprising a push-activated switch 26 and a movable plunger 28. The plunger 28 comprises a button contact area 30 for contacting with the button of the outer shell (not shown) when the frame assembly 16 is inserted into the outer shell. The plunger 28 further comprises a switch contact area 32 for contacting with the push-activated switch 26 when the movable plunger 28 is pushed downwards by a user pressing onto the button fixed onto the outer shell. The plunger 28 comprises two legs 34. The plunger 28 is mounted on the frame assembly 16 with the two legs 34 to create a spring force to automatically return the plunger 28, and thus the button, after having been pushed down by a user.

FIG. 6A schematically shows a setup of an injection moulding process. The moulding process comprises a step of positioning an outer mold 36 on top of the through-hole 20 from an outer side of the outer shell 10. The moulding process comprises a step of positioning an inner mold 38 beneath the through-hole 20 from an inner side of the outer shell 10. The through-hole 20 and the groove 22 of the wall 14 of the outer shell 10 are located between the outer mold 36 and the inner mold 38. Arrows indicate the injection path of molten material via channels in the inner mold 36. Alternatively or in addition, the channels for injecting molten material may be in the outer mold 38. The moulded button 12 will thus be fixed onto the groove 22 as shown in FIG. 6B.

Using the setup of FIG. 6A, the moulded button 12 shown in FIG. 6B is arranged flush with an inner surface of a wall 14 of the outer shell 10 to facilitate smooth insertion of the frame assembly (not shown) into the outer shell 10. Also, the groove 22 may allow to further improve a durable connection between the button 12 and the outer shell 10.

The outer mold 38 of FIG. 6A additionally comprises a recess 40. Thereby, a central bump 42 of the button 12 at an outer surface of the wall 14 of the outer shell 10 will be provided as shown in FIG. 6B. The central bump 42 may allow for a tactile haptic feedback.

FIG. 7 shows a portion of an outer shell 10 provided with a corrugated retaining structure onto the groove 22 before fixing a button onto the groove 22.

The corrugated retaining structure comprises a laser engraved pitch pattern. The pitch pattern comprises a grid shape of squared pitches of about 0.2 millimeters in side length separated by grooves of at least 0.03 millimeters in depth.

The corrugated retaining structure may additionally improve the durability of the connection between the button (not shown) and the outer shell 10 when the button is fixed to the groove 22 by a moulding process. Optionally, durability of the connection between the button and the outer shell 10 may even be further improved by spraying an adhesive onto the laser engraved pitch pattern before moulding the button onto the groove 22.

1. A method for assembling an aerosol-generating device comprising steps of,
providing an outer shell for an aerosol-generating device, the outer shell being configured to internally receive a frame assembly comprising a push-activated switch;
providing a through-hole on a wall of the outer shell;
fixing a button onto the outer shell to cover the through-hole; and
inserting the frame assembly into the outer shell such that the button overlays the push-activated switch.

2. The method of claim 1, wherein the button is fixed onto the outer shell by a moulding process, preferably an injection overmoulding process, more preferably a plastic injection overmoulding process.

3. The method of claim 1, wherein the step of fixing the button onto the outer shell is carried out before the step of inserting the frame assembly into the outer shell.

4. The method of claim 3, wherein the moulding process comprises steps of,
positioning an outer mold on top of the through-hole from an outer side of the outer shell;
positioning an inner mold beneath the through-hole from an inner side of the outer shell; and
injecting, via channels in the inner mold, molten material into a cavity formed between the outer mold and the inner mold to form the button.

5. The method of claim 1, comprising a step of providing a groove onto the outside of the outer shell around the periphery of the through-hole,
wherein the button is fixed onto the groove of the outer shell.

6. The method of claim 5, comprising a step of providing a corrugated retaining structure onto the groove before fixing the button onto the groove.

7. The method of claim 6, wherein the corrugated retaining structure comprises a pitch pattern, and wherein the pitch pattern comprises a grid shape of squared pitches of about 0.2 millimeters in side length separated by grooves of at least 0.03 millimeters in depth.

8. The method of any of claim 6, wherein the corrugated retaining structure is provided by a laser engraving process.

9. The method of claim 6, comprising a step of applying an adhesive onto the corrugated retaining structure before fixing the button onto the groove.

10. The method of claim 1, wherein the outer shell and the button comprise different materials, preferably, wherein one or both of the outer shell comprises a metal, preferably aluminium, and the button comprises plastics, preferably thermoplastic polyurethane.

11. The method of claim 1, wherein the button is arranged flush with an inner surface of a wall of the outer shell to facilitate smooth insertion of the frame assembly into the outer shell.

12. The method of claim 11, wherein the button is arranged flush with the wall of the outer shell apart from a central bump at an outer surface of the outer shell to allow for a tactile haptic feedback.

13. The method according to claim 1, wherein the button is fixed onto the outer shell to cover the through-hole so as to provide a water-tight seal between the button and the outer shell according to IPX7.

14. An aerosol-generating device, comprising
an outer shell comprising a button extending over a through-hole of the outer shell, wherein the button is fixed directly onto the outer shell; and
a frame assembly comprising a push-activated switch, wherein the frame assembly is slidably inserted into the outer shell such that the button overlays the push-activated switch.

15. The aerosol-generating device of claim 14, wherein the outside of the outer shell comprises a groove around the periphery of the through-hole, wherein the groove comprises a laser engraved pattern, wherein glue is applied onto the laser engraved pattern, and wherein the button is moulded onto the groove.
